(19) United States
(12) Patent Application Publication
(10) Pub. No.: US 2004/0083618 A1
(43) Pub. Date: May 6, 2004

(54) High visibility taper gauge

(76) Inventor: Michael W. Kelly, Joliet, IL (US)

Correspondence Address: Kevin W. Guynn, SONNENSCHEIN NATH & ROSENTHAL, Wacker Drive Station, Sears Tower, P.O. Box #061080, Chicago, IL, 60606-1080, US

(21) Appl. No.: 10/284,979

(22) Filed: Oct. 31, 2002

(51) Int. Cl. G01B 3/00

(52) U.S. Cl. 33/544.4

(57) ABSTRACT

A taper gauge comprising an elongated body having a tapered length with a generally flat face. A slide element is slidingly carried on the body and has a portion which overlies the face. A plurality of measurement markings are provided on the face. The face and the measurement markings are provided in contrasting colors to one another to enhance a visibility of the markings

### BACKGROUND OF THE INVENTION

The present invention is directed to taper gauges.

Mechanical taper gauges are known devices which comprise an elongated member or body which is tapered along its length so as to be insertable into a space having an interior dimension to be measured. The gauge is inserted into the space until it can no longer be inserted due to the increasing thickness of the gauge striking the sides of the space to be measured, usually between two objects. Then a sliding device carried on the gauge is moved up to engage with the object defining the space. A visible scale on a flat or planar face of the taper gauge is then consulted to determine a thickness of the gauge at the point at which the slide has stopped and has engaged the object defining the opening.

The scales carried on the taper gauges require marking thereon of sufficiently large size so as be readily visible in factory and power plant conditions which do not always have the best lighting conditions and which include environments causing the taper gauge scale to become dirty and hard to read. Therefore, the markings on the gauges typically are spaced apart to provide adjacent readings differing by at least five thousandths of an inch. Typically the taper gauges are made of steel with a polished silver finish and the markings are made by engraving numbers onto the slot face of the elongated member.

### SUMMARY OF THE INVENTION

It is an object of the present invention to provide a taper gauge which provides a greater visibility for the markings carried on the gauge.

It is further an object of the invention to provide a taper gauge where the markings and the portion of the taper gauge body surrounding the markings are provided in contrasting colors.

It is a further object of the invention to provide a taper gauge where the markings are provided in a light color to enhance their visibility in poorly lit environments.

To provide these objects, there is provided a taper gauge comprising an elongated member or body which diminishes in at least one lateral dimension along its length. Such a taper gauge could be straight along its length or could be curved along its length. If curved, the tapering dimension could be that which is a radial dimension as viewed from the radius of curvature, or could be tapered in a direction perpendicular to this radial direction.

A movable stop member is carried on the taper gauge and is movable along the length of the gauge such that it has a portion which overlies a face of the taper gauge body. The face is generally flat or planar, at least across its width, in the case of a curved taper gauge, and along its length as well, in the case of a straight taper gauge. Markings are provided on the face of the taper gauge in a color which contrasts with a color of at least the face of the taper gauge. In one aspect of the invention, the face of the taper gauge is provided in a dark color and the markings are provided in a light color. In a particular aspect of the invention, the face is provide in a black color and the markings are provided in a white color.

In an aspect of the invention, the markings comprise engraved recesses with paint therein. In an aspect of the invention, the planar face is coated with a black oxide. In a particular embodiment of the taper gauge, the taper gauge has a second planar face on a side opposite the planar face, the two faces being positioned at an acute angle relative to each other. In a particular embodiment of the taper gauge, the body is formed of steel. In a particular embodiment of the taper gauge, the series of markings extend along the tapered length.

In an embodiment of the invention, a taper gauge is provided which comprises a taper gauge member having a diminishing profile in at least one lateral dimension along its length, a face, being substantially flat along at least one dimension, provided along at least a portion of the length, a movable stop member carried on the taper gauge member and movable along the length with a portion overlying the face and a series of markings provided on the face, wherein the markings and the face are provided in contrasting colors relative to each other.

### BRIEF DESCRIPTION OF THE DRAWING

FIG. 1 is a side elevational schematic view of a taper gauge of the present invention.

FIG. 2 is a plan view of the gauge of FIG. 1.

FIG. 3 is an enlarged partial view of a slidable member carried on the gauge of FIG. 2.

FIG. 4 is a side elevational view of an alternative embodiment of the taper gauge.

FIG. 5 is a top view of an alternative embodiment of the taper gauge.

FIG. 6 is a side view of the taper gauge of FIG. 5.

### DETAILED DESCRIPTION OF THE PREFERRED EMBODIMENT

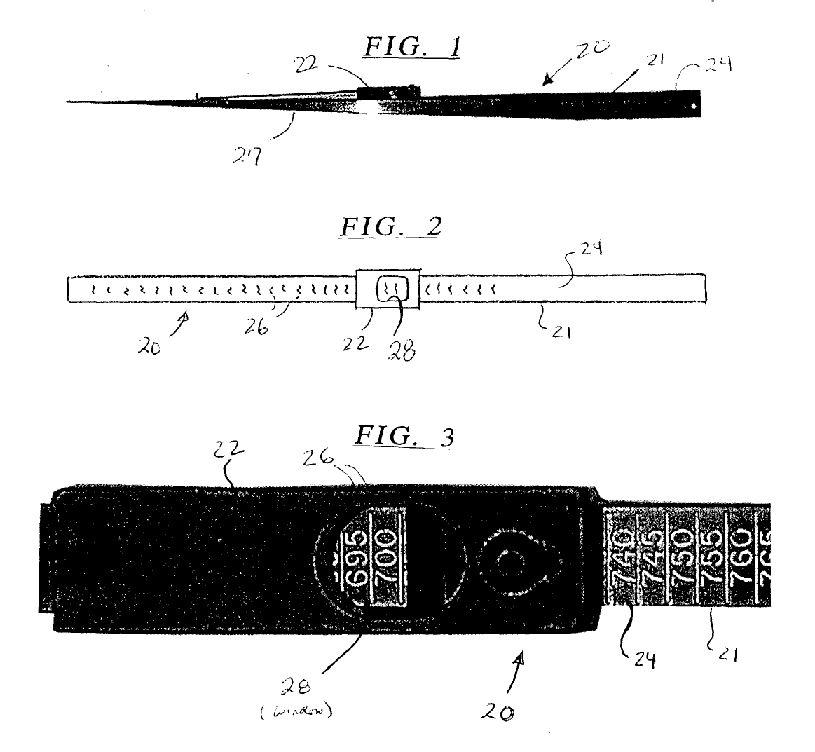

FIGS. 1 and 2 schematically illustrates schematically the elements embodying the present invention. In this figure there is shown a taper gauge generally at 20 which comprises an elongated member or body 21 diminishing in at least one lateral dimension along its length. As seen in this figure, the taper gauge profile tapers towards the left in this side view. Thus, the thickness of the gauge diminishes along the length. Carried on the taper gauge 20 is a movable stop member 22. This movable stop member is slidable along the length of the taper gauge 20. A top face 24 containing a plurality of markings 26 is arranged on the taper gauge 20 and the movable stop member 22 has a portion which overlies the face 24. The markings 26 may be provided in a series extending along the length of the body 21 and typically indicate thickness measurements The face 24 is generally flat or planar, at least in one dimension. That is, in the embodiment shown in FIGS. 1 and 2, the face 24 is flat along the length of the taper gauge 20, as well as across its width.

The taper gauge 20 may be provided with a second face 27 lying opposite the top face 24, with an acute angle being formed between the two faces. In an embodiment the body 21 may be made of steel, but other materials could be used as well.

As seen in more detail in FIG. 3, the movable member 22 may have a window 28 or a free end which overlies the markings 26 so that a reading may be made. In accordance with the invention, the color of the face 24 and the color of the markings 26 are provided in contrasting hues in order to increase the visibility of the markings. In an embodiment of the invention the face 24 is provided in a dark color and the markings are provided in a light color. In a specific embodiment, the face 24 is provided in a black color, such as by providing a black oxide coating on the body 21 and the markings 26 are provided in a white color, such as by engraving the markings into the face 24 and then applying a white paint to the recesses of the engraving. Other known methods of marking may be used as well.

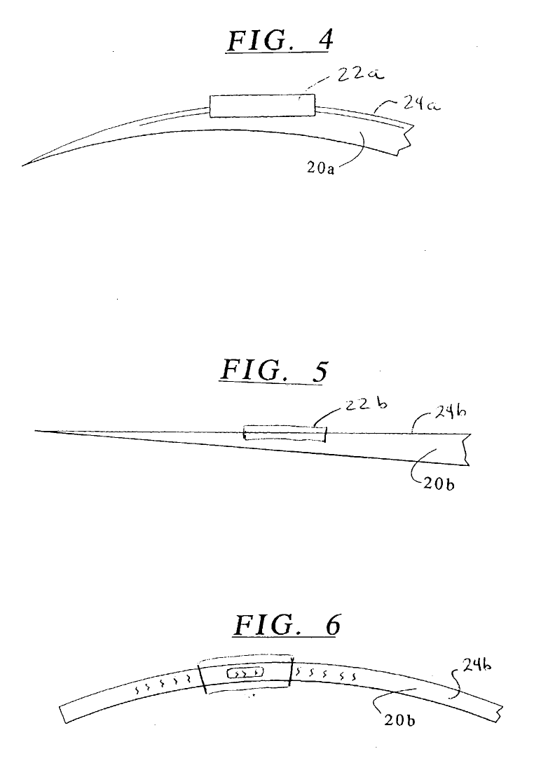

The taper gauge 20 may be straight along its length, or may be curved in the event that the gap to be measured represents a curved gap, such as that often found in the area of rotors and other structures found in motors, turbines, etc. FIG. 4 illustrates a curved tapered gauge 20a in which the radial thickness, as viewed along a radius line defining the radius of curvature of the taper gauge, diminishes along its length. FIGS. 5 and 6 illustrate an arrangement where the taper gauge 20b has a radius of curvature, but the thickness remains constant in the radial direction and diminishes in a direction perpendicular to the radial dimension. These arrangements of taper gauges would also carry a movable stop member 22a, 22b with a portion overlying a face 24a, 24b containing a plurality of markings 26b as described above. The face 24a, 24b is generally flat at least across a width of the body. Other aspects of the invention described above would be applicable to these configurations of taper gauges as well.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

The embodiments of the invention in which an exclusive property or privilege is claimed are defined as follows:

1. A taper gauge comprising:
an elongated body having a tapered length with a generally flat face;
a slide element slidingly carried on said body and having a portion which overlies said face; and
a series of measurement markings permanently affixed to said face;
said face and said measurement markings being provided in contrasting colors to one another to enhance a visibility of said markings.

2. The taper gauge of claim 1, wherein said face is provided in a dark color and said marking are provided in a light color.

3. The taper gauge of claim 2, wherein said face is provided in a black color and said markings are provided in a white color.

4. The taper gauge of claim 1, wherein said markings comprise engraved recesses with paint therein.

5. The taper gauge of claim 1, wherein said face is coated with a black oxide.

6. The taper gauge of claim 1, wherein said taper gauge has a second generally flat face on a side opposite said face, said two faces being positioned at an acute angle relative to each other.

7. The taper gauge of claim 1, wherein said series of markings extend along said tapered length.

8. A taper gauge comprising:
an elongated body having a tapered length with a first generally flat face and a second, opposite generally flat face;
a slide element slidingly carried on said body and having a portion which overlies said first face; and
a plurality of measurement markings permanently affixed to said first face;
said first face being provided in a dark color and said measurement markings being provided in a light color to enhance a visibility of said markings.

9. The taper gauge of claim 8, wherein said face is provided in a black color and said markings are provided in a white color.

10. The taper gauge of claim 8, wherein said markings comprise engraved recesses with paint therein.

11. The taper gauge of claim 8, wherein said first face is coated with a black oxide.

12. The taper gauge of claim 8, wherein said two faces are positioned at an acute angle relative to each other.

13. The taper gauge of claim 8, wherein said body is formed of steel.

14. The taper gauge of claim 8, wherein said plurality of markings extend along said tapered length.

15. A taper gauge comprising:
a taper gauge member having a diminishing profile in at least one lateral dimension along its length;
a face, being substantially flat along at least one dimension, provided along at least a portion of said length;
a movable stop member carried on said taper gauge member and movable along said length with a portion overlying said face;
a plurality of markings provided on said face;
said markings and said face being provided in contrasting colors relative to each other.

16. The taper gauge of claim 15, wherein said face is provided in a dark color and said marking are provided in a light color.

17. The taper gauge of claim 16, wherein said face is provided in a black color and said markings are provided in a white color.

18. The taper gauge of claim 16, wherein said face is coated with a black oxide.

19. The taper gauge of claim 15, wherein said markings comprise engraved recesses with paint therein.

20. The taper gauge of claim 15, wherein said plurality of markings extend along said length.
